(19) United States
(12) Patent Application Publication
(10) Pub. No.: US 2008/0193853 A1
(43) Pub. Date: Aug. 14, 2008

(54) Lithium Salts of Pyrroldinium Type Zwitterion and the Preparation Method of the Same

(75) Inventors: Hong-Gon Kim, Seoul (KR); Sang-Deuk Lee, Seoul (KR); Byoung-Sung Ahn, Seoul (KR); Je-Seung Lee, Seoul (KR); Un-Seok Kim, Seoul (KR); Byung-Won Cho, Seoul (KR); Hoon-Sik Kim, Seoul (KR)

Correspondence Address: BROWDY AND NEIMARK, P.L.L.C.;624 NINTH STREET, NW, SUITE 300, WASHINGTON, DC, 20001-5303, US

(73) Assignee: Korea Institute of Science and Technology, Seoul (KR)

(21) Appl. No.: 11/910,157

(22) PCT Filed: Oct. 28, 2005
(86) PCT No.: PCT/KR2005/003615

§ 371 Date: Nov. 28, 2007

(30) Foreign Application Priority Data
Mar. 29, 2005 (KR) 10-2005-0026075

(51) Int. Cl. H01M 10/26

(52) U.S. Cl. 429/328

(57) ABSTRACT

Disclosed are a pyrrolidinium type sulphonated zwitterion, a method of preparing the same, a lithium salt prepared by using the same, a method of preparing the salt, an electrolytic composition containing the salt and a lithium secondary battery including the electrolytic composition. Since the pyrrolidinium type sulphonated zwitterions prepared according to the invention are thermally and electrochemically stable, the lithium salt prepared by using the same exhibits a lower hygroscopicity than the conventional lithium salts and strong thermal and electrochemical stabilities. When the lithium salt of the invention is dissolved in an organic solvent independently or together with the ionic liquid, excellent conductivity and electrochemical stability are exhibited. Accordingly, the lithium salt of the invention is very suitable for the electrolyte of the lithium secondary battery.

### TECHNICAL FIELD

The present invention relates to a pyrrolidinium type sulphonated zwitterion, a method of preparing the same, a lithium salt prepared by using the same, a method of preparing the salt, an electrolytic composition containing the salt and a lithium secondary battery including the electrolytic composition.

### BACKGROUND ART

An electrochemical storing system such as battery, storage battery and the like requires an electrolyte consisting of a conductive salt and a non-protonic organic solvent. A lithium secondary battery of high-performance secondary batteries which are currently commercialized is the most recently developed battery. The lithium secondary battery has a high energy density, rapid charge/discharge characteristics and an excellent cycle performance and has rapidly expanded its markets such as mobile phone, notebook computer battery and the like.

All lithium secondary batteries coming into the markets use lithium hexafluorophosphate (LiPF₆) as the conductive salt. The lithium salt is well dissolved in a non-protonic organic solvent and exhibits high conductivity and electrochemical stability.

However, the lithium hexafluorophosphate has a serious problem of thermal stability from which serious side effects are caused. That is, if a part thereof is dissociated into LiF and PF₅, even though they are small quantities, the solvent of the electrolyte can cause a cationic polymerization due to PF₅ which is Lewis acid.

In addition, if a small quantity of water is contacted, there occurs strong corrosive HF, so that it is very difficult to handle it due to the toxicity and corrosiveness thereof and it may cause a dissolution action of a transition metal oxide used for a reduction electrode material (for example, LiMn₂O₄). Accordingly, it has a negative influence on the stability for a long time use.

Accordingly, there have been steadily performed researches on other lithium salts capable of replacing the lithium hexafluorophosphate. In particular, there have been performed researches on lithium salts of fluorinated organics. For example, there are lithium trifluoromethanesulfonate (LiO₃SCF₃, hereinafter referred to as lithium triflate), lithium his (trifluoromethanesulfonyl)imide (LiN(O₂SCF₃)₂), lithium methide such as lithium tristrifluoromethanesulfonylmethide (LiC(O₂SCF₃)₃) and the like.

However, the lithium triflate does not exhibit a sufficient conductivity in an organic solvent and the imide salt has a characteristic of corroding an aluminum plate used in a battery. The methide salt exhibits a conductivity comparable to the lithium hexafluorophosphate but a unit cost of production thereof is too expensive, so that it is not commercialized.

In addition, as disclosed in DE 19633027 A1, lithium bis[1,2-benzenediolato]borate, which is lithium salt of boron acid compound prepared by using an organic having not been replaced with fluorine, exhibits better properties than the above lithium salts, but is decomposed at an oxidation potential much lower than the lithium hexafluorophosphate. Accordingly, in case of chelated boron acids, only derivatives replaced with fluorine are sufficiently stable for the oxidation.

Although lithium tris[1,2-benzenediolatophosphate, which is chelated phosphate, exhibits more electrochemical stability than the above mentioned boron acid, an electrolyte prepared with the phosphate has a too low conductivity (M. Handa et al., Electrochemical and Solide-State Letter, 2(2), pp 60-62, 1999).

Lithium tris(oxalato)phosphate disclosed in U.S. Pat. No. 6,693,212 B1 (U. Wietelmann et al.) exhibits a higher conductivity and has an excellent solubility in an organic solvent. However, according to cyclic voltammogram measured by U. Wietelmann et al., it was observed that a part of oxalic acid coordinated to phosphorous was decomposed.

### DISCLOSURE OF INVENTION

### Technical Problem

The inventors did researches on a novel lithium salt capable of overcoming the problems of the lithium hexafluorophosphate used for an electrolytic composition of a lithium secondary battery, i.e., low thermal stability and toxicity, corrosiveness and explosiveness due to water-sensitivity and exhibiting excellent conductivity and electrochemical stability in an organic solvent. During the researches, the inventors prepared zwitterions having thermal and electrochemical stabilities and a lithium salt using the zwitterions. As a result, it was validated that the salt was same as the prior fluorine organic lithium salt except the zwitterions but exhibited properties different from the fluorine organic lithium salt due to an interaction with the zwitterions.

Accordingly, an object of the invention is to provide a pyrrolidinium type sulphonated zwitterion having thermal and electrochemical stabilities, a method of preparing the same, a novel lithium salt prepared by using the same, and a method of preparing the salt.

Another object of the invention is to provide an electrolytic composition using the lithium salt and a lithium secondary battery including the electrolytic composition.

### Technical Solution

In order to achieve the above objects, there is provided a pyrrolidinium type sulphonated zwitterion for a lithium secondary battery electrolyte expressed by a following chemical formula 1,

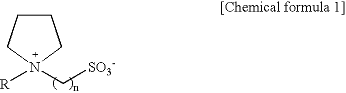

where, n: integer of 3 or 4, and

R: methyl, ethyl, propyl, butyl, pentyl, hexyl, methylester, ethylester, methyl methylcarbonate, methyl ethylcarbonate, methyl propylcarbonate, ethyl ethylcarbonate or vinyl group.

In addition, according to the invention, there is provided a method of preparing the pyrrolidinium type sulphonated zwitterion for a lithium secondary battery electrolyte expressed by the chemical formula 1, wherein 1-alkylpyrrolidine and propane sulton or butane sulton in a following reaction 1 are reflux-reacted under nitrogen atmosphere.

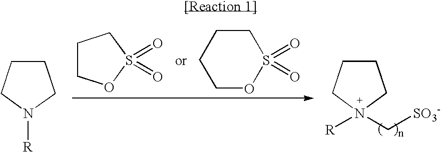

where, n: integer of 3 or 4, and

R: methyl, ethyl, propyl, butyl, pentyl, hexyl, methylester, ethylester, methyl methylcarbonate, methyl ethylcarbonate, methyl propylcarbonate, ethyl ethylcarbonate or vinyl group.

In addition, according to the invention, there is provided a lithium salt for a lithium secondary battery electrolyte prepared by using the pyrrolidinium type sulphonated zwitterion for a lithium secondary battery electrolyte expressed by the chemical formula 1, and expressed by a chemical formula 2.

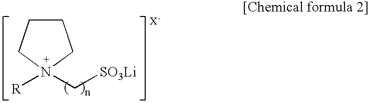

where, n: integer of 3 or 4, and

R: methyl, ethyl, propyl, butyl, pentyl, hexyl, methylester, ethylester, methyl methylcarbonate, methyl ethylcarbonate, methyl propylcarbonate, ethyl ethylcarbonate or vinyl group, and

X: nitrate, perchloric acid, acetate, trifluoroacetate, triflate, bis(trifluoromethanesulfonyl)imide, tetrafluoroborate or hexafluorophosphate.

In addition, according to the invention, there is provided a method of preparing the lithium salt for a lithium secondary battery electrolyte expressed by the chemical formula 2, the method comprising a first step of reflux-reacting 1-alkylpyrrolidine and propane sulton or butane sulton in the reaction 1 under nitrogen atmosphere to prepare pyrrolidinium type sulphonated zwitterions, and a second step of reacting the pyrrolidinium type sulphonated zwitterions obtained in the first step with a lithium salt in a following reaction 2.

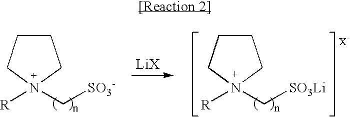

where, n: integer of 3 or 4, and

R: methyl, ethyl, propyl, butyl, pentyl, hexyl, methylester, ethylester, methyl methylcarbonate, methyl ethylcarbonate, methyl propylcarbonate, ethyl ethylcarbonate or vinyl group, and

X: nitrate, perchloic acid, acetate, trifluoroacetate, triflate, bis(trifluoromethanesulfonyl)imide, tetrafluoroborate or hexafluorophosphate.

Further, according to the invention, there is provided an electrolytic composition for a lithium secondary battery including the lithium salt expressed by the above chemical formula 2 and an organic solvent.

According to an embodiment of the invention, a content of the lithium salt expressed by the chemical formula 2 may be 5 wt % to 25 wt % based on a total weight of the electrolytic composition.

According to an embodiment of the invention, the organic solvent may be at least one selected from a group consisting of ethylene carbonate, propylene carbonate, dimethyl carbonate, ethyl acetate, acetone, acetonitrile, gamma-butyrolactone, tetrahydrofuran, 1,4-dioxane, 2-methyltetrahydrofuran, dimethylsulfoxide, sulforane, 1-methylpyrrolidone, N,N-dimethylformamide, dimethoxyethane, diglyme, triglyme, tetragylme and a mixture thereof.

According to an embodiment of the invention, a content of the organic solvent may be 50 wt % to 95 wt % based on a total weight of the electrolytic composition.

According to an embodiment of the invention, the electrolytic composition may further comprise ionic liquid.

According to an embodiment of the invention, the ionic liquid may be at least one selected from a group consisting of pyrrolidinium, imidazolium, piperidinium, pyridinium, ammonium and morpholinium.

According to an embodiment of the invention, the lithium salt expressed by the chemical formula 2 and the ionic liquid may be mixed in a weight ratio of 1:1.

According to an embodiment of the invention, the electrolytic composition may be further added with a variety of additives such as adhesive enhancer, filler and the like so as to improve a mechanical strength of the electrolyte and an interface performance with an electrode.

According to the invention, there is provided a lithium secondary battery including the electrolytic composition.

### Advantageous Effects

Since the pyrrolidinium type sulphonated zwitterions prepared according to the invention are thermally and electrochemically stable, the lithium salt prepared by using the same exhibits a lower hygroscopicity than the conventional lithium salts and strong thermal and electrochemical stabilities. When the lithium salt of the invention is dissolved in an organic solvent independently or together with the ionic liquid, excellent conductivity and electrochemical stability are exhibited. Accordingly, the lithium salt of the invention is very suitable for the electrolyte of the lithium secondary battery.

### BRIEF DESCRIPTION OF THE DRAWINGS

FIG. 1 is a view showing measurements of conductivity when there are hexafluorophosphate lithium 1-methylpyrrolidinium-1-propanesulfonate and an organic solvent;

FIG. 2 is a view showing measurements of conductivity when there are hexafluorophosphate lithium 1-methylpyrrolidinium-1-propanesulfonate, an organic solvent and an ionic liquid; and

FIG. 3 is a view showing measurements of an electrochemical stability of hexafluorophosphate lithium 1-methylpyrrolidinium-1-propanesulfonate.

### BEST MODE FOR CARRYING OUT THE INVENTION

A zwitterion is meant by a molecule which is electrically neutral on the whole but whose part of positive charge and part of negative charge are divided in the molecule. It is known that the zwitterion can generally maintain electrochemically and physically considerable stable states.

The inventors prepared a lithium salt by using the thermally and electrochemically stable zwitterions. As a result, it was observed that the novel lithium salt exhibited better conductivity and electrochemical stability than the conventional lithium salts.

It is thought that an electron density of sulfonate having negative charges of the zwitterions is biased to pyrrolidinium due to positive charges of the pyrrolidinium and thus the sulfonate acts as a strong acid. In addition, the positive charges of pyrrolidinium stabilize hexafluorophosphate and thus an excellent conductivity of lithium ions is exhibited. Further, the lithium salt of the invention can be more electrochemically stable due to the actions of the zwitterions.

### MODE FOR THE INVENTION

Hereinafter, the invention will be more specifically described with reference to examples and experimental examples. However, it should be noted that the invention is not limited thereto.

### EXAMPLE 1

### Preparation of Zwitterions (1)

In this example 1, pyrrolidinium type sulphonated zwitterions for a lithium secondary battery electrolyte expressed by the above chemical formula 1 were prepared as follows.

First, 1,3-propane sulton 12.2 g (0.1 mole) was dissolved in acetone 20 □, slowly dropped to 1-methylpyrrolidine 8.5 g (0.1 mole) dissolved in acetone 30 □ and then subject to a reflux operation for about 12 hours under nitrogen atmosphere. After that, it was cooled to a room temperature, filtered, washed with acetone for several times and then dried with low pressures, thereby providing 1-methylpyrrolidinium-1-propanesulfonate with 95% yields which was white solids of zwitterions.

### EXAMPLE 2

### Preparation of Zwitterions (2)

In this example 2, pyrrolidinium type sulphonated zwitterions for a lithium secondary battery electrolyte expressed by the above chemical formula 1 were prepared as follows.

First, 1,4-butane sulton 13.6 g (0.1 mole) was dissolved in acetone 20 □, slowly dropped to 1-methylpyrrolidine 8.5 g (0.1 mole) dissolved in acetone 30 □ and then subject to a reflux operation for about 12 hours under nitrogen atmosphere. After that, it was cooled to a room temperature, filtered, washed with acetone for several times and then dried with low pressures, thereby providing 1-methylpyrrolidinium-1-butanesulfonate with 93% yields which was white solids of zwitterions.

### EXAMPLE 3

### Preparation of Lithium Salt (1)

The 2.07 g (10 mmol) 1-methylpyrrolidinium-1-propanesulfonate obtained in the example 1 was put in methanol 20 □, added with a solution obtained by dissolving lithium triflate 1.56 g (10 mmol) in methanol 10 □ and then stirred for 12 hours. After that, the mixture solution was filtered and washed with methanol for several times and then dried, thereby providing triflate lithium 1-methylpyrrolidinium-1-propanesulfonate with 98% yields which was white solids of zwitterions.

### EXAMPLE 4

### Preparation of lithium salt (2)

The 2.07 g (10 mmol) 1-methylpyrrolidinium-1-propanesulfonate obtained in the example 1 was put in methanol 20 □, added with a solution obtained by dissolving lithium tetrafluoroborate 0.94 g (10 mmol) in methanol 10 □ and then stirred for 12 hours. After that, the mixture solution was filtered and washed with methanol for several times and then dried, thereby providing tetrafluoroborate lithium 1-methylpyrrolidinium-1-propanesulfonate with 93% yields which was white solids of zwitterions.

### EXAMPLE 5

### Preparation of Lithium Salt (3)

The 2.07 g (10 mmol) 1-methylpyrrolidinium-1-propanesulfonate obtained in the example 1 was put in methanol 20 □, added with a solution obtained by dissolving lithium hexafluorophosphate 1.52 g (10 mmol) in methanol 10 □ and then stirred for 12 hours. After that, the mixture solution was filtered and washed with methanol for several times and then dried, thereby providing hexafluorophosphate lithium 1-methylpyrrolidinium-1-propanesulfonate with 95% yields which was white solids of zwitterions.

### EXAMPLE 6

### Preparation of Lithium Salt (4)

The 2.21 g (10 mmol) 1-methylpyrrolidinium-1-butanesulfonate obtained in the example 2 was put in methanol 20 □, added with a solution obtained by dissolving lithium triflate 1.56 g (10 mmol) in methanol 10 □ and then stirred for 12 hours. After that, the mixture solution was filtered and washed with methanol for several times and then dried, thereby providing triflate lithium 1-methylpyrrolidinium-1-butanesulfonate with 96% yields which was white solids of zwitterions.

### EXAMPLE 7

### Preparation of Lithium Salt (5)

The 2.21 g (10 mmol) 1-methylpyrrolidinium-1-butanesulfonate obtained in the example 2 was put in methanol 20 □, added with a solution obtained by dissolving lithium hexafluorophosphate 1.52 g (10 mmol) in methanol 10 □ and then stirred for 12 hours. After that, the mixture solution was filtered and washed with methanol for several times and then dried, thereby providing hexafluorophosphate lithium 1-methylpyrrolidinium-1-butanesulfonate with 94% yields which was white solids of zwitterions.

### EXPERIMENTAL EXAMPLE 1

### Conductivity Measurement of Lithium Salt of the Invention (1)

The hexafluorophosphate lithium 1-methylpyrrolidinium-1-propanesulfonate prepared in the example 5 was dissolved in a mixture solution having 1:1 of ethylene carbonate (EC) and dimethyl carbonate (DMC) in an amount of 1.5˜17 wt % and then a conductivity thereof was measured with a Model 150A plus Conductivity Meter available from Orion Company.

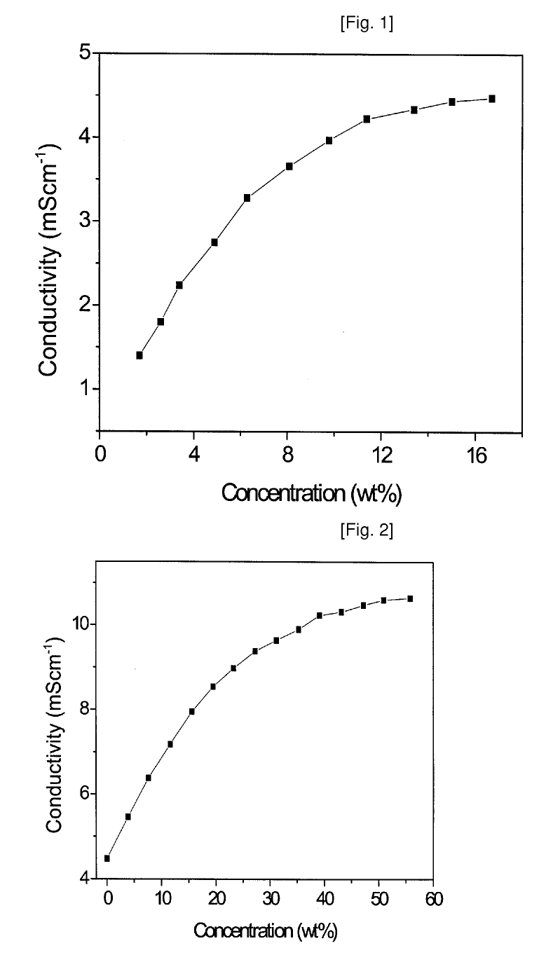

As a result, it could be seen that it exhibited an improved conductivity of 4.5 mScm-¹ as shown in FIG. 1.

This is because an electron density of sulfonate having negative charges of the zwitterions is biased to pyrrolidinium due to positive charges of pyrrolidinium and thus the sulfonate acts as a strong acid.

### EXPERIMENTAL EXAMPLE 2

### Conductivity Measurement of Lithium Salt of the Invention (2)

The hexafluorophosphate lithium 1-methylpyrrolidinium-1-propanesulfonate prepared in the example 5 was dissolved in a mixture solution having 1:1 of ethylene carbonate (EC) and dimethyl carbonate (DMC) in an amount of 17 wt % based on the solution weight and then a conductivity thereof was measured with a Model 150A plus Conductivity Meter available from Orion Company while adding 4˜56 wt % of 1-methyl-3-ethylimidazolium bis(trifluoromethanesulfonyl)imide at 20° C. which was ionic liquid.

As a result, it could be seen that it exhibited an improved conductivity of 10.6 mScm⁻¹ at 56 wt %, as shown in FIG. 2. This is the highest value of the conductivities at 20° C. that has been ever reported.

This is because the ionic liquid stabilized the dissociated lithium salt to increase the ion concentration and the high ion conductivity of the ionic liquid itself increased the conductivity of the prepared electrolyte.

### EXPERIMENTAL EXAMPLE 3

### Measurement of Electrochemical Stability of Lithium Salt of the Invention

In order to examine the electrochemical stability of the hexafluorophospahte lithium 1-methylpyrrolidinium-1-propanesulfonate prepared in the example 5, it was dissolved in a mixture solution having 1:1 of ethylene carbonate (EC) and dimethyl carbonate (DMC) in an amount of 16 wt % and then it was measured cyclic voltammogram with a Model 660A Electrochemical Analyzer available from CH Instruments. A glass carbon electrode was used as an electrode, a platinum wire was used as a counter electrode and a silver wire was used as a reference electrode. A measurement rate was 10 mVS⁻¹.

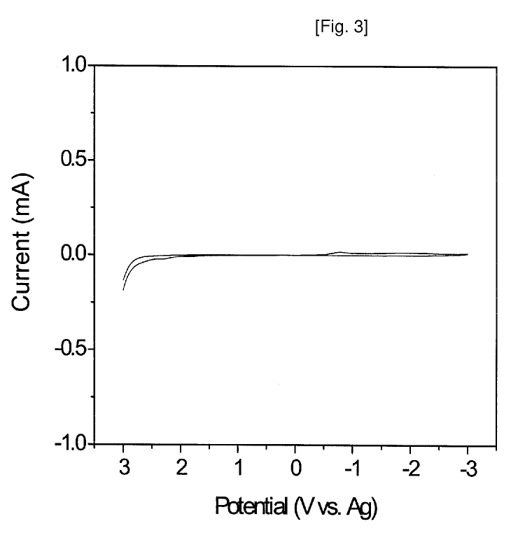

As a result, as shown in FIG. 3, it was validated that it exhibited a wide electrochemical stability of about 5.5 V over −3.3V˜2.5V (vs. Ag).

### INDUSTRIAL APPLICABILITY

As described above, since the pyrrolidinium type sulphonated zwitterions prepared according to the invention are thermally and electrochemically stable, the lithium salt prepared by using the same exhibits a lower hygroscopicity than the conventional lithium salts and strong thermal and electrochemical stabilities. When the lithium salt of the invention is dissolved in an organic solvent independently or together with the ionic liquid, excellent conductivity and electrochemical stability are exhibited. Accordingly, the lithium salt of the invention is very suitable for the electrolyte of the lithium secondary battery.

While the invention has been shown and described with reference to certain preferred embodiments thereof, it will be understood by those skilled in the art that various changes in form and details may be made thereto without departing from the spirit and scope of the invention as defined by the appended claims.

1. A pyrrolidinium type sulphonated zwitterion for a lithium secondary battery electrolyte expressed by a following chemical formula 1, 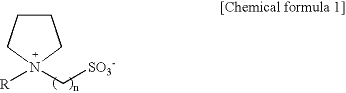
where, n: integer of 3 or 4, and
R: methyl, ethyl, propyl, butyl, pentyl, hexyl, methylester, ethylester, methyl methylcarbonate, methyl ethylcarbonate, methyl propylcarbonate, ethyl ethylcarbonate or vinyl group.

2. A method of preparing the pyrrolidinium type sulphonated zwitterion for a lithium secondary battery electrolyte expressed by the chemical formula 1 defined in claim 1, wherein 1-alkylpyrrolidine and propane sulton or butane sulton in a following reaction 1 are reflux-reacted under nitrogen atmosphere. 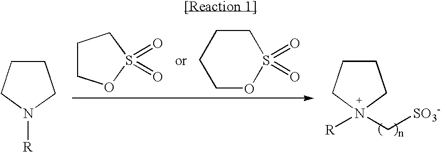
where, n: integer of 3 or 4, and
R: methyl, ethyl, propyl, butyl, pentyl, hexyl, methylester, ethylester, methyl methylcarbonate, methyl ethylcarbonate, methyl propylcarbonate, ethyl ethylcarbonate or vinyl group.

3. A lithium salt for a lithium secondary battery electrolyte expressed by a chemical formula 2. 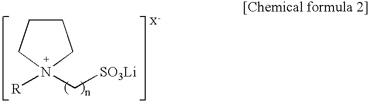
where, n: integer of 3 or 4, and
R: methyl, ethyl, propyl, butyl, pentyl, hexyl, methylester, ethylester, methyl methylcarbonate, methyl ethylcarbonate, methyl propylcarbonate, ethyl ethylcarbonate or vinyl group, and
X: nitrate, perchloric acid, acetate, trifluoroacetate, triflate, bis(trifluoromethanesulfonyl)imide, tetrafluoroborate or hexafluorophosphate.

4. A method of preparing the lithium salt expressed by the chemical formula 2 defined in claim 3, the method comprising:
a first step of reflux-reacting 1-alkylpyrrolidine and propane sulton or butane sulton in a following reaction 1 under nitrogen atmosphere to prepare pyrrolidinium type sulphonated zwitterions, and
a second step of reacting the pyrrolidinium type sulphonated zwitterions obtained in the first step with a lithium salt in a following reaction 2. 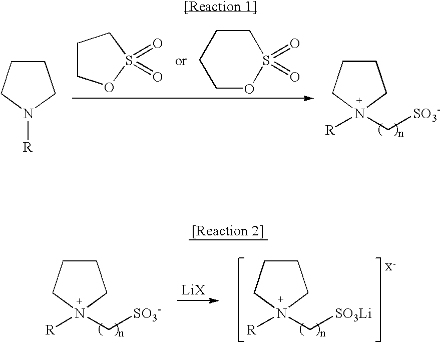
where, n: integer of 3 or 4, and
R: methyl, ethyl, propyl, butyl, pentyl, hexyl, methylester, ethylester, methyl methylcarbonate, methyl ethylcarbonate, methyl propylcarbonate, ethyl ethylcarbonate or vinyl group, and
X: nitrate, perchloric acid, acetate, trifluoroacetate, triflate, bis(trifluoromethanesulfonyl)imide, tetrafluoroborate or hexafluorophosphate.

5. An electrolytic composition for a lithium secondary battery including a lithium salt expressed by a following chemical formula 2 and an organic solvent, 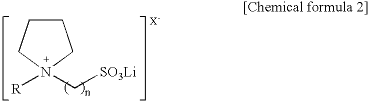
where, n: integer of 3 or 4, and
R: methyl, ethyl, propyl, butyl, pentyl, hexyl, methylester, ethylester, methyl methylcarbonate, methyl ethylcarbonate, methyl propylcarbonate, ethyl ethylcarbonate or vinyl group, and
X: nitrate, perchloric acid, acetate, trifluoroacetate, triflate, bis(trifluoromethanesulfonyl)imide, tetrafluoroborate or hexafluorophosphate.

6. The electrolytic composition according to claim 5, further comprising an ionic liquid.

7. The electrolytic composition according to claim 6, wherein the ionic liquid is at least one selected from a group consisting of pyrrolidinium, imidazolium, piperidinium, pyridinium, ammonium and morpholinium.

8. The electrolytic composition according to claim 5, wherein the organic solvent is at least one selected from a group consisting of ethylene carbonate, propylene carbonate, dimethyl carbonate, ethyl acetate, acetone, acetonitrile, gamma-butyrolactone, tetrahydrofuran, 1,4-dioxane, 2-methyltetrahydrofuran, dimethylsulfoxide, sulforane, 1-methylpyrrolidone, N,N-dimethylformamide, dimethoxyethane, diglyme, triglyme, tetragylme and a mixture thereof.

9. A lithium secondary battery including the electrolytic composition according to claim 5.
